(19) United States
(12) Patent Application Publication
(10) Pub. No.: US 2009/0200160 A1
(43) Pub. Date: Aug. 13, 2009

(54) Thermal Reaction Type Smell Emitting Device and Electrical Equipment Using the Same

(76) Inventors: Tomiya Abe, Hitachi (JP); Susumu Kumagai, Ibaraki (JP); Hironori Sato, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/658,887

(22) PCT Filed: Sep. 21, 2006
(86) PCT No.: PCT/JP2006/018732

§ 371 Date: Feb. 20, 2007

(30) Foreign Application Priority Data
Sep. 21, 2005 (JP) 2005-274167

(51) Int. Cl. G01K 11/06

(52) U.S. Cl. 204/196.02

(57) ABSTRACT

A thermal reaction type smell emitting device 1 wherein a smell substance 3 is housed in a container 2 with a smell releasing port 4 formed thereon, and the smell releasing port 4 is sealed with a sealing material 5 to be melted at a predetermined temperature. A layer 6 for preventing the scattering of the smell substance 3 is disposed outside the container 2.

### TECHNICAL FIELD

This invention relates to a thermal reaction type smell emitting device and, in particular, to a thermal reaction type smell emitting device that is adapted to emit a smell to indicate the incidence of an abnormal overheating phenomenon in electrical equipment. Also, this invention relates to electrical equipment using the smell emitting device.

### BACKGROUND ART

Conventionally, in electrical facilities and consumer electrical equipments, when overcurrent flows and temperature thereof is increased abnormally due to an increase in load, a contact failure, an electrical leakage etc., a malfunction or an overheating hazard may be caused thereby.

A method for preventing the overheating hazard before it occurs is, for example, proposed in which a color changeable tape to change in color with an increase in temperature is previously attached to a site where heat generation may occur and the abnormal heat generation phenomenon is detected by confirming visually whether the color is changed or not. However, the method has problems that it is necessary to always watch the color changeable tape, and that it is difficult to accurately detect a local heat generation phenomenon occurring inside the equipment.

Also, a method may be assumed in which an electrical thermal resistance type temperature sensor is previously attached to a site where heat generation may occur, and the incidence of abnormal heat generation phenomenon is alarmed by a warning beep etc. However, the temperature sensor is generally expensive, and it is not practical in view of a production cost since plural temperature sensors, wires, and alarming devices need to be set in its installation.

Therefore, recently, a method for detecting the incidence of the abnormal overheating phenomenon is proposed (for example, refer to Patent Literatures 1 to 3 described below) in which a resin capsule, tape or tube encapsulating a smell substance such as alcohols is previously attached to a site where heat generation may occur, so that an emitted smell can be perceived directly by a person being near the site or indirectly by a gas detecting device when the capsule etc. encapsulating the smell substrate is melted by the generated heat to release the smell substance outside.

Patent Literature 1: JP-A-H05-18831

Patent Literature 2: JP-A-H06-66646

Patent Literature 3: Jp-A-H06-66647

### DISCLOSURE OF THE INVENTION

### Problems to be Solved by the Invention

However, the conventional smell emitting capsule has problems that, in detecting the abnormal overheating temperature, the smell substance in liquid state may scatter around the capsule so that it contaminates a device disposed around the capsule and decreases the electrical insulating performance of the device.

It is an object of the invention to provide a thermal reaction type smell emitting device that can prevent the contamination and electrical insulation failure of a peripheral device in detecting the abnormal overheating temperature so as to enhance reliability thereof.

It is a further object of the invention to provide electrical equipment using the smell emitting device.

### Means for Solving the Problems

According to one embodiment of the invention, a thermal reaction type smell emitting device comprises:

a container comprising at least one smell releasing port;

a smell substance housed in the container;

a sealing material that seals the smell releasing port and is adapted to be melted at a predetermined temperature; and

a layer disposed around the smell releasing port to control scattering of the smell substance in liquid state.

Further, according to one embodiment of the invention, a thermal reaction type smell emitting device comprises:

a container comprising at least one smell releasing port;

a smell substance housed in the container;

a sealing material that seals the smell releasing port and is adapted to be melted at a predetermined temperature; and

a layer disposed in the container to retain the smell substance.

The antiscattering layer comprises a porous material. The porous material comprises desirably a sponge material comprising interconnected pores therein.

The sealing material comprises a low melting alloy comprising a melting point of 50° C. to 180° C. The low melting alloy comprises desirably an indium-tin alloy, a tin-bismuth alloy, an indium-bismuth alloy or an indium-tin-bismuth alloy.

By using the sealing material, wrong operation can be prevented in which the device operates at a temperature lower than an abnormal overheating temperature or does not operate even when reaching the abnormal overheating temperature. Thus, the incidence of the abnormal overheating phenomenon can be surely alarmed.

The thermal reaction type smell emitting device can be used by being attached to an electrical charge portion included in a main body of electrical equipment.

### ADVANTAGES OF THE INVENTION

According to one embodiment of the invention, a thermal reaction type smell emitting device can prevent the fluid scattering and leakage of the smell substance in liquid state in case of detecting the abnormal overheating temperature. Thus, it can prevent the contamination and electrical insulation failure of the peripheral device to enhance reliability thereof.

### BRIEF DESCRIPTION OF THE DRAWINGS

FIG. 1 is a perspective view showing a thermal reaction type smell emitting device in a first preferred embodiment according to the invention,

FIG. 2(a) is a cross sectional view showing a state (i.e., a state before its operation) that the thermal reaction type smell emitting device as shown in FIG. 1 is attached to a heat generation site,

FIG. 2(b) is a cross sectional view showing a state after the operation of the thermal reaction type smell emitting device as shown in FIG. 1,

FIG. 3 is a perspective view showing a thermal reaction type smell emitting device in a second preferred embodiment according to the invention,

FIG. 4(a) is a cross sectional view showing a state (i.e., a state before its operation) that the thermal reaction type smell emitting device as shown in FIG. 3 is attached to a heat generation site,

FIG. 4(b) is a cross sectional view showing a state after the operation of the thermal reaction type smell emitting device as shown in FIG. 3,

FIG. 5 is a perspective view showing a thermal reaction type smell emitting device in comparative example relative to the invention,

FIG. 6(a) is a cross sectional view showing a state (i.e., a state before its operation) that the thermal reaction type smell emitting device as shown in FIG. 5 is attached to a heat generation site, and

FIG. 6(b) is a cross sectional view showing a state after the operation of the thermal reaction type smell emitting device as shown in FIG. 5.

### EXPLANATION OF REFERENCE NUMERALS

1 thermal reaction type smell emitting device
2 container
3 smell substance
4 smell releasing port
5 sealing material (low melting alloy)
6 antiscattering layer
7 heat generating site
8 smell substance-retaining layer disposed in the container

### DETAILED DESCRIPTION OF THE PREFERRED EMBODIMENTS

The preferred embodiments according to the invention will be explained below referring to the attached drawings.

### First Embodiment

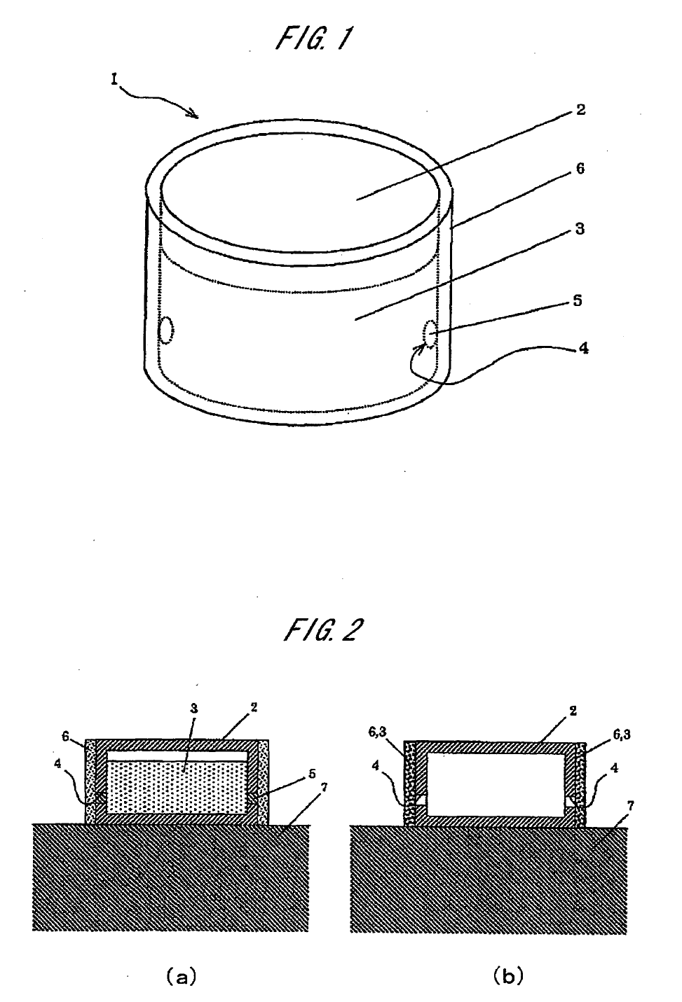

FIG. 1 is a perspective view showing a thermal reaction type smell emitting device in the first preferred embodiment according to the invention. As shown in FIG. 1, the thermal reaction type smell emitting device 1 comprises a can-shaped container 2 comprising two smell releasing ports 4 on its side wall, a smell substance 3 housed in the container 2, a sealing material 5 having a low melting point and sealing the smell releasing port 4, and a tape (e.g., a sponge tape with interconnected pores) 6 wound outside the sealing material 5 and the container 2 corresponding to the periphery of the smell releasing port 4 to cover the sealing material 5 (or to block the smell releasing port 4) so as to prevent the smell substance 3 from scattering in liquid state.

The tape 6 has a thickness of about 0.1 mm to 5 mm which is excellent in antiscattering performance for the smell substance 3 and in winding easiness. If the tape 6 is too thin, the antiscattering performance may be reduced. If the tape 6 is too thick, problems may arise that the tape 6 becomes difficult to wind and the thermal reaction type smell emitting device 1 becomes too large in size.

The tape 6 needs to have a function to keep a liquid (i.e., the smell substance 3) therein. It is preferably formed of a porous material such as a cloth, a paper, a nonwoven fabric and a sponge material. In particular, it is preferably formed of a porous sponge material (or a foamed material). Of the porous sponge material, urethane foams and melamine foams are excellent.

With regard to the form of the pores, an interconnected type that the pores are communicated with each other is superior to an independent type that the pores are formed individually and independently, in terms of the liquid keeping performance and smell volatility.

The pores are preferably about 0.01 mm to 0.5 mm in diameter in terms of the liquid keeping performance. If the diameter is less than 0.01 mm, a problem may arise that it takes a long time to cause the liquid to be introduced and permeated inside the tape and that release of the liquid is blocked. If the diameter is more than 0.5 mm, a problem may arise that the liquid is difficult to keep inside the tape, thereby causing an abrupt release thereof.

A foaming ratio (=a density of a base resin/a density of a foaming material), which corresponds to a ratio between the resin and pores in the sponge material, is desirably as large as possible. The foaming ratio is preferably about 5 to 100 times. If the foaming ratio is more than 100 times, the pores become undesirably dispersed in diameter.

The container 2 enclosing the smell substance 3 is not particularly limited in material if it is formed of a material that can house the smell substance 3 stably. It can be formed of an inorganic material such as a metal, a glass and a ceramic as well as an organic material such as a plastic. However, in view of the property required, it is preferably a metal container formed of a metal or alloy that is excellent in especially thermal conductivity and long-term stability. The container 2 is not particularly limited in shape and can be, for example, capsule-shaped or box-shaped.

On the other hand, the smell substance 3 enclosed in the container 2 is not particularly limited if it can be vaporized by heat and perceived by a human sense of smell or if it can be easily perceived by an electric gas detecting sensor. The smell substance 3 includes: for example, alcohols such as ethanol, propanol, butanol and phenol; unsaturated hydrocarbons such as ethylene, acetylene, butadiene, benzene and naphthalene; ketones such as acetone and methyl ethyl ketone; carboxylic acids such as formic acid, acetic acid, lactic acid, acrylic acid and methacrylic acid; and esters such as methyl acetate and ethyl acetate. In the case that a smell detecting device to detect the smell substance 3 based on oxidation reaction of an organic material is used together, it is preferable to use so-called flammable substances such as ethanol, toluene and xylene.

Further, the sealing material 5 for sealing the smell releasing port 4 of the container 2 includes a low melting alloy (or metal) having a melting point that is lower than that of the container 2 and falls within, e.g., 50° C. to 180° C., just lower than a temperature range where an overheating hazard or a device malfunction caused by overheating may occur. If the melting point of the low melting alloy is less than 50° C., the temperature difference from room temperature is too small to distinguish the abnormal overheating state from the normal state, and it is difficult to obtain the alloy with the melting point less than 50° C. On the contrary, if the melting point of the low melting alloy is more than 180° C. (i.e., if temperature of the abnormal overheating is more than 180° C.), a monitored device may be highly damaged and decomposition of an organic material used in the monitored device may be advanced so that an electrical smell sensor can be operated by the decomposed gas, where it becomes unnecessary to use the thermal reaction type smell emitting device 1 of the embodiment.

The low melting alloy to satisfy the above conditions includes optimally an indium-tin ally, a tin-bismuth alloy, an indium-bismuth alloy, an indium-tin-bismuth alloy etc. By changing suitably a composition ratio in each of the alloys, a low melting alloy with an arbitrary melting point can be easy obtained.

The tape 6 is formed as a layer (i.e., an antiscattering layer) for preventing the smell substance 3 from scattering in liquid state. The antiscattering layer 6 is used to prevent the contamination of a peripheral device and an electric insulation breakdown caused by the smell substance 3 when the smell releasing port 4 is opened to allow the smell substance 3 in liquid state to spurt from the port 4 and to scatter abruptly outside the container 2. Thus, it is used to release the smell substance 3 gently. The antiscattering layer 6 is formed of a paper, a cloth, a nonwoven fabric, a sponge material etc., preferably a sponge material having interconnected pores.

The operation of the thermal reaction type smell emitting device 1 of the first embodiment will be explained below.

As shown in FIG. 2(a), the thermal reaction type smell emitting device 1 is disposed in the vicinity of a monitored heat generating site 7 such as a motor, an integrated circuit and a switchboard. The thermal reaction type smell emitting device 1 may be directly attached to the heat generating site 7 by using an adhesive.

As shown in FIG. 2(b), when temperature of the heat generating site 7 becomes higher than usual temperature due to overheating and exceeds the melting point of the sealing material 5 which is set slightly lower than the abnormal overheating temperature, the sealing material 5 is melted by the heat and the smell releasing port 4 are opened. It is preferred that the smell releasing port 4 is positioned lower than half the height of the container 2 in order to utilize the smell substance 3 efficiently and to improve its temperature responsivity to the abnormal overheating.

By the opening of the smell releasing port 4, the smell substance 3 housed in the container 2 is scattered and released outside from the smell releasing port 4. Then, the smell substance 3 scattered and released is absorbed by the antiscattering layer 6, permeated in the antiscattering layer 6, and retained therein temporarily.

Thus, the smell substance 3 can be prevented from scattering in liquid form on the peripheral device around the container 2 so as not to cause the contamination or electric insulation breakdown of the peripheral device. The smell substance 3 retained by the antiscattering layer 6 evaporates gradually and slowly so that it can be diffused in the air during a relatively long period.

Therefore, a person being near the smell emitting device 1 can directly and surely perceive the smell of the smell substance 3 by his sense of smell so that he can note the existence of the smell substance 3. Alternatively, a gas detecting sensor etc. can detect the smell of the smell substance 3, and, e.g., by sounding an alarm, a person being near the smell emitting device 1 can indirectly know the existence of the smell substance 3. When the smell substance 3 is thus detected, it can be known that the monitored heat generating site 7 is overheated and the overheating hazard may be caused thereby. Thus, the overheating hazard can be prevented from occurring.

Although the abnormal overheating temperature at the heat generating site 7 may be ranged widely, the thermal reaction type smell emitting device 1 can have very high temperature response accuracy since the melting point of the sealing material 5 can be flexibly set according to the abnormal overheating temperature by adjusting the alloy composition of the low melting alloy. Therefore, wrong operation can be prevented in which the device 1 operates at a temperature lower than the abnormal overheating temperature or does not operate even when reaching the abnormal overheating temperature. Thus, the incidence of the abnormal overheating phenomenon can be surely alarmed.

In the case that the monitored heat generating site 7 has a large size or covers a wide region, the plural thermal reaction type smell emitting devices 1 can be set collectively or at predetermined intervals. In this case, by pursuing its smell source, the heat generating or overheating site can be rapidly and surely specified.

### Second Embodiment

FIG. 3 is a perspective view showing a thermal reaction type smell emitting device in the second preferred embodiment according to the invention. In FIG. 3 the same components as in FIG. 1 are indicated by the same reference numerals and the detail explanation is omitted below.

As shown in FIG. 3, the thermal reaction type smell emitting device 31 comprises a can-shaped container 2 comprising the two smell releasing ports 4 on its side wall, a smell substance 3 housed in the container 2, a sealing material 5 having a low melting point and sealing the smell releasing port 4, and a layer (or retaining layer) 8 disposed in the container 2 for retaining the smell substance 3 to prevent the material 3 from scattering outside.

The retaining layer 8 for retaining the smell substance 3 is used to prevent the contamination of a peripheral device and an electric insulation breakdown caused by the smell substance 3 when the smell releasing port 4 is opened to allow the smell substance 3 in liquid state to spurt from the port 4 and to scatter abruptly outside the container 2. Thus, it is used to release the smell substance 3 gently.

The retaining layer 8 is not limited in size and shape if it can be housed in the container 2.

The retaining layer 8 needs to have a function to keep a liquid (i.e., the smell substance 3) therein. It is preferably formed of a porous material such as a cloth, a paper, a nonwoven fabric and a sponge material. In particular, it is preferably formed of a porous sponge material (or a foamed material). Of the porous sponge material, urethane foams and melamine foams are excellent.

With regard to the form of the pores, an interconnected type that the pores are communicated with each other is superior to an independent type that the pores are formed individually and independently, in terms of liquid keeping performance and smell volatility.

The pores are preferably about 0.01 mm to 0.5 mm in diameter in terms of the liquid keeping performance. If the diameter is less than 0.01 mm, a problem may arise that it takes a long time to cause the liquid to be introduced and permeated inside the layer and that release of the liquid is blocked. If the diameter is more than 0.5 mm, a problem may arise that the liquid is difficult to keep inside the layer, thereby causing an abrupt release thereof.

A foaming ratio (=a density of a base resin/a density of a foaming material), which corresponds to a ratio between the resin and pores in the sponge material, is desirably as large as possible. The foaming ratio is preferably about 5 to 100 times. If the foaming ratio is more than 100 times, the pores become undesirably dispersed in diameter.

As shown in FIG. 4(a), the thermal reaction type smell emitting device 31 of the embodiment is disposed in the vicinity of a monitored heat generating site 7.

As shown in FIG. 4(b), when temperature of the heat generating site 7 becomes higher than usual temperature due to overheating and exceeds the melting point of the sealing material 5 which is set slightly lower than the abnormal overheating temperature, the sealing material 5 is melted by the heat and the smell releasing port 4 are opened.

Even when the smell releasing port 4 is opened, the smell substance 3 in the container 2 can be absorbed by the retaining layer 8 housed in the container 2 as well, permeated in the retaining layer 8, and retained therein temporarily. Thereby, the smell substance 3 can be prevented from be scattered and released outside in liquid state.

Thus, the smell substance 3 can be prevented from abruptly scattering in liquid form on the peripheral device around the container 2 so as not to cause the contamination or electric insulation breakdown of the peripheral device. The smell substance 3 retained by the retaining layer 8 evaporates gradually and slowly so that it can be diffused in the air during a relatively long period.

The thermal reaction type smell emitting device 31 of the second embodiment can have the same effects and functions as the thermal reaction type smell emitting device 1 of the first embodiment.

### Comparative Example

FIG. 5 is a perspective view showing a thermal reaction type smell emitting device in comparative example relative to the invention.

The thermal reaction type smell emitting device 51 is structured such that the antiscattering layer 6 is removed from the thermal reaction type smell emitting device 1 as shown in FIG. 1, or such that the retaining layer 8 is removed from the thermal reaction type smell emitting device 31 as shown in FIG. 3. Thus, the smell emitting device 51 does not have a measure to prevent the smell substance 3 from being scattered and released in liquid state.

As shown in FIG. 6(a), the thermal reaction type smell emitting device 51 in comparative example is disposed in the vicinity of a monitored heat generating site 7.

As shown in FIG. 6(b), when temperature of the heat generating site 7 becomes higher than usual temperature due to overheating and exceeds the melting point of the sealing material 5 slightly lower than the abnormal overheating temperature, the sealing material 5 is melted down by the heat to open the smell releasing ports 4.

On this occasion, since the smell emitting device 51 does not have the measure to prevent the smell substance 3 in the container 2 from being scattered and leaked in liquid state, the smell substance 3 may be scattered in liquid state at the heat generating site 7 around the container 2 to contaminate the device or to lower the electric insulation of the device.

Thus, the thermal reaction type smell emitting device 51 in comparative example cannot have the same effects and functions as the thermal reaction type smell emitting device 1 of the first embodiment and the thermal reaction type smell emitting device 31 of the second embodiment.

### INDUSTRIAL APPLICABILITY

By using the thermal reaction type smell emitting device according to the invention with enhanced reliability relating to the detection of abnormal overheating temperature, the incidence of the abnormal overheating phenomenon in electrical equipment can be alarmed accurately and surely.

1. A thermal reaction type smell emitting device, comprising:
a container comprising at least one smell releasing port;
a smell substance housed in the container;
a sealing material that seals the smell releasing port and is adapted to be melted at a predetermined temperature; and
a layer disposed around the smell releasing port to control scattering of the smell substance in liquid state.

2. A thermal reaction type smell emitting device, comprising:
a container comprising at least one smell releasing port;
a smell substance housed in the container;
a sealing material that seals the smell releasing port and is adapted to be melted at a predetermined temperature; and
a layer disposed in the container to retain the smell substance.

3. The thermal reaction type smell emitting device according to claim 1, wherein:
the layer comprises a porous material.

4. The thermal reaction type smell emitting device according to claim 3, wherein:
the porous material comprises a sponge material comprising interconnected pores therein.

5. The thermal reaction type smell emitting device according to claim 1, wherein:
the sealing material comprises a low melting alloy comprising a melting point of 50° C. to 180° C.

6. The thermal reaction type smell emitting device according to claim 5, wherein:
the low melting alloy comprises an indium-tin alloy, a tin-bismuth alloy, an indium-bismuth alloy or an indium-tin-bismuth alloy.

7. An electrical equipment, comprising:
a main body, and
the thermal reaction type smell emitting device according to claim 1 attached to an electrical charge portion included in the main body.

8. The thermal reaction type smell emitting device according to claim 2, wherein:
the layer comprises a porous material.

9. The thermal reaction type smell emitting device according to claim 8, wherein:
the porous material comprises a sponge material comprising interconnected pores therein.

10. The thermal type smell emitting device according to claim 2, wherein:
the sealing material comprises a low melting alloy comprising a melting point of 50° C. to 180° C.

11. The thermal type smell emitting device according to claim 3, wherein:
the sealing material comprises a low melting alloy comprising a melting point of 50° C. to 180° C.

12. The thermal type smell emitting device according to claim 4, wherein:
the sealing material comprises a low melting alloy comprising a melting point of 50° C. to 180° C.

13. The thermal reaction type smell emitting device according to claim 10, wherein:
the low melting alloy comprises indium-tin alloy, a tin-bismuth alloy, an indium-bismuth alloy, or an indium-tin-bismuth alloy.

14. The thermal reaction type smell emitting device according to claim 11, wherein:
the low melting alloy comprises indium-tin alloy, a tin-bismuth alloy, an indium-bismuth alloy, or an indium-tin-bismuth alloy.

15. The thermal reaction type smell emitting device according to claim 12, wherein:
the low melting alloy comprises indium-tin alloy, a tin-bismuth alloy, an indium-bismuth alloy, or an indium-tin-bismuth alloy.

16. An electrical equipment comprising:
a main body, and
the thermal reaction type smell emitting device according to claim 2 attached to an electrical charge portion included in the main body.

17. An electrical equipment comprising:
a main body, and
the thermal reaction type smell emitting device according to claim 3 attached to an electrical charge portion included in the main body.

18. An electrical equipment comprising:
a main body, and
the thermal reaction type smell emitting device according to claim 4 attached to an electrical charge portion included in the main body.

19. An electrical equipment comprising:
a main body, and
the thermal reaction type smell emitting device according to claim 5 attached to an electrical charge portion included in the main body.

20. An electrical equipment comprising:
a main body, and
the thermal reaction type smell emitting device according to claim 6 attached to an electrical charge portion included in the main body.
